(19) United States
(12) Patent Application Publication
(10) Pub. No.: US 2026/0229779 A1
(43) Pub. Date: Aug. 6, 2026

(54) ANTENNA SYSTEM

(71) Applicant: WNC Corporation, Hsinchu (TW)

(72) Inventors: Pao-Chuan PENG, Hsinchu (TW); Hsieh-Chih LIN, Hsinchu (TW)

(21) Appl. No.: 19/302,637

(22) Filed: Aug. 18, 2025

(30) Foreign Application Priority Data
Feb. 6, 2025 (TW) 114104330

(51) Int. Cl. H01Q 5/35; H01Q 21/06

(52) U.S. Cl. CPC H01Q 5/35; H01Q 21/06

(57) ABSTRACT

An antenna system includes first to seven radiation elements, and a tunable circuit. The first radiation element has a first feeding point. The second radiation element is adjacent to the first radiation element. The third radiation element has a second feeding point. The fourth radiation element is adjacent to the third radiation element. The second radiation element and the fourth radiation element are coupled through the fifth radiation element to the tunable circuit. The tunable circuit provides a variable impedance value according to a control signal. A first antenna structure is formed by the first radiation element, the second radiation element, and the fifth radiation element. A second antenna structure is formed by the third radiation element, the fourth radiation element, the fifth radiation element, the sixth radiation element, and the seventh radiation element.

### CROSS-REFERENCE TO RELATED PATENT APPLICATION

This application claims the benefit of priority to Taiwan Patent Application No. 114104330, filed on Feb. 6, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna system, in particular to a wideband antenna system.

### BACKGROUND OF THE DISCLOSURE

With the development of mobile communication technology, mobile devices have become increasingly popular in recent years. Common examples include laptop computers, mobile phones, multimedia players, and other multifunctional portable electronic devices. To meet users'needs, mobile devices typically feature wireless communication capabilities. Some support long-range wireless communication, such as mobile phones operating with 2G, 3G, LTE (Long Term Evolution) systems, which use communication bands at 700 MHz, 850 MHz, 900 MHz, 1800 MHz, 1900 MHz, 2100 MHz, 2300 MHz, and 2500 MHz. Others support short-range wireless communication, such as Wi-Fi and Bluetooth systems operating in the 2.4GHz, 5.2GHz, and 5.8GHz bands.

An antenna is an indispensable component in the field of wireless communication. If the bandwidth of the antenna used for receiving or transmitting signals is insufficient, the communication quality of the mobile device can be easily degraded. Therefore, designing a compact, wideband antenna system is a critical challenge for antenna designers.

### SUMMARY OF THE DISCLOSURE

In a preferred embodiment, the present disclosure provides an antenna system comprising: a first radiation element having a first feeding point; a second radiation element adjacent to the first radiation element; a third radiation element having a second feeding point; a fourth radiation element adjacent to the third radiation element; a tunable circuit coupled to a ground voltage, wherein the tunable circuit provides a variable impedance value according to a control signal; a fifth radiation element, through which the second radiation element and the fourth radiation element are coupled to the tunable circuit; a sixth radiation element coupled to the ground voltage, wherein the sixth radiation element is adjacent to the third radiation element; and a seventh radiation element coupled to the fourth radiation element, wherein the seventh radiation element is adjacent to the second radiation element. The first radiation element, second radiation element, and fifth radiation element form a first antenna structure; the third radiation element, fourth radiation element, fifth radiation element, sixth radiation element, and seventh radiation element form a second antenna structure.

In some embodiments, the antenna system further includes a carrier element having a first surface and a second surface opposite to each other. The first radiation element, second radiation element, third radiation element, fourth radiation element, fifth radiation element, and sixth radiation element are all disposed on the first surface, while the seventh radiation element is disposed on the second surface. The seventh radiation element is coupled to the fourth radiation element via a conductive via element.

In some embodiments, a first coupling gap is formed between the first radiation element and the second radiation element, and the width of the first coupling gap is between 0.15 mm and 4 mm.

In some embodiments, a second coupling gap is formed between the third radiation element and the fourth radiation element, and the width of the second coupling gap is between 0.15 mm and 4 mm.

In some embodiments, a third coupling gap is formed between the third radiation element and the sixth radiation element, and the width of the third coupling gap is between 0.15 mm and 1 mm.

In some embodiments, a fourth coupling gap is formed between the second radiation element and the seventh radiation element, and the width of the fourth coupling gap is between 0.15 mm and 5 mm.

In some embodiments, the tunable circuit includes: a first capacitor coupled to the ground voltage; a second capacitor coupled to the ground voltage; a third capacitor coupled to the ground voltage; a fourth capacitor coupled to the ground voltage; a fifth capacitor coupled to the ground voltage; and a switch element, coupled to the fifth radiation element, wherein the switch element is switchable between the first capacitor, second capacitor, third capacitor, fourth capacitor, and fifth capacitor based on the control signal.

In some embodiments, the capacitance of the first capacitor is between 12 pF and 18 pF, the capacitance of the second capacitor is between 4 pF and 7 pF, the capacitance of the third capacitor is between 2.5 pF and 4 pF, the capacitance of the fourth capacitor is between 1.5 pF and 2.5 pF, and the capacitance of the fifth capacitor is between 0.5 pF and 1.5 pF.

In some embodiments, the tunable circuit further includes a proximity sensor coupled to the fifth radiation element, wherein the second radiation element, fourth radiation element, fifth radiation element, and seventh radiation element serve as sensing pads of the proximity sensor.

In some embodiments, the antenna system covers a first frequency band, a second frequency band, a third frequency band, a fourth frequency band, and a fifth frequency band.

In some embodiments, the first frequency band ranges from 617 MHz to 960 MHz, the second frequency band ranges from 1427 MHz to 2690 MHz, the third frequency band ranges from 3300 MHz to 3980 MHz, the fourth frequency band ranges from 4200 MHz to 4700 MHz, and the fifth frequency band ranges from 5150 MHz to 5925 MHz.

In some embodiments, the first radiation element includes a first branch, a second branch, a third branch, and a fourth branch, and an open slot is formed between the first branch and the second branch.

In some embodiments, the length of the first branch is substantially equal to 0.25 wavelength of the second frequency band.

In some embodiments, the length of the second branch is substantially equal to 0.25 wavelength of the third frequency band.

In some embodiments, the length of the third branch is substantially equal to 0.25 wavelength of the fourth frequency band.

In some embodiments, the length of the fourth branch is substantially equal to 0.25 wavelength of the fifth frequency band.

In some embodiments, the total length of the second radiation element and the fifth radiation element from 0.125 to 0.25 wavelength of the first frequency band.

In some embodiments, the third radiation element includes a protruding branch, and the length of the protruding branch is from 0.125 to 0.25 wavelength of the fourth frequency band.

In some embodiments, the total length of the fourth radiation element and the fifth radiation element is from 0.125 to 0.25 wavelength of the second frequency band.

In some embodiments, the length of the sixth radiation element is from 0.125 to 0.25 wavelength of the fourth frequency band.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a top view illustrating an antenna system according to an embodiment of the present disclosure;

FIG. 2 is a side view illustrating an antenna system according to an embodiment of the present disclosure;

FIG. 3 is a structural diagram of a tunable circuit according to an embodiment of the present disclosure;

FIG. 4 is a return loss diagram of a first antenna structure of an antenna system according to an embodiment of the present disclosure; and

FIG. 5 is a return loss diagram of a second antenna structure of an antenna system according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The term “approximate” or “roughly” refers to the acceptable range of error within which a person having ordinary skill in the art can address the technical issues and achieve the fundamental technical effect. Furthermore, the term “couple” in the present disclosure includes any direct and indirect means of electrical connection. Therefore, if the disclosure describes a first device coupled to a second device, it means that the first device can be directly electrically connected to the second device or indirectly electrically connected to the second device through other devices or connection means.

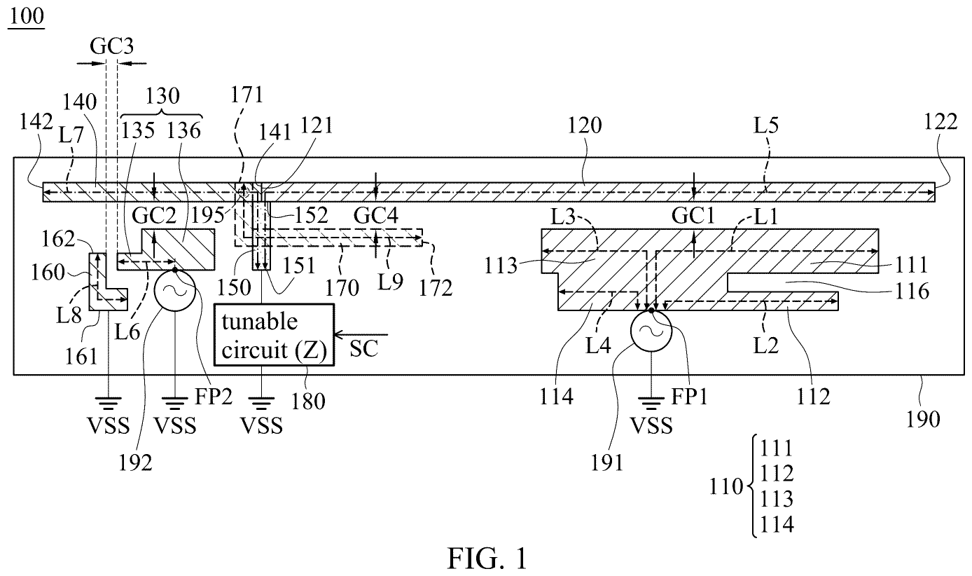

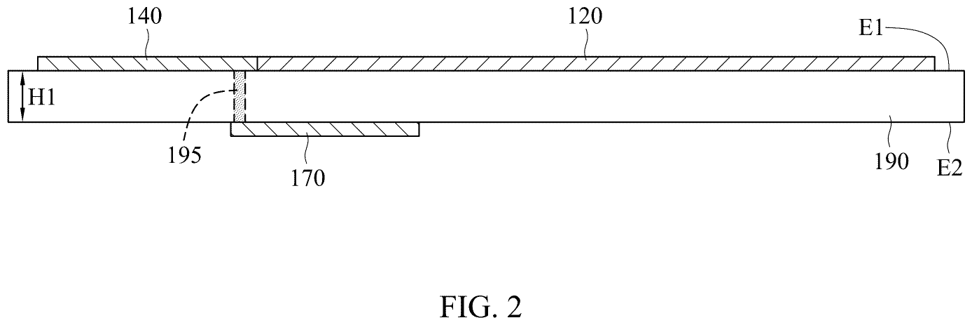

FIG. 1 is a top view illustrating an antenna system 100 according to an embodiment of the present disclosure. FIG. 2 is a side view of the antenna system 100. Please refer to both FIGS. 1 and 2. The antenna system 100 may be applied to a mobile device such as a smartphone, tablet computer, or notebook computer. In the embodiments of FIGS. 1 and 2, the antenna system 100 includes at least a first radiation element 110, a second radiation element 120, a third radiation element 130, a fourth radiation element 140, a fifth radiation element 150, a sixth radiation element 160, a seventh radiation element 170, and a tunable circuit 180. The first radiation element 110, the second radiation element 120, the third radiation element 130, the fourth radiation element 140, the fifth radiation element 150, the sixth radiation element 160, and the seventh radiation element 170 may all be made of metallic materials, such as copper, silver, aluminum, iron, or their alloys.

The first radiation element 110 includes a first branch 111, a second branch 112, a third branch 113, and a fourth branch 114. Each of the first branch 111, the second branch 112, the third branch 113, and the fourth branch 114 is coupled to a first feeding point FP1. The first feeding point FP1 may be coupled to a positive electrode of a first signal source 191, while the negative electrode of the first signal source 191 may be coupled to a ground voltage VSS. For example, the first signal source 191 may be a radio frequency RF module, and the ground voltage VSS may be provided by a system ground plane of the antenna system 100 (not shown). In some embodiments, an open slot 116 may be formed between the first branch 111 and the second branch 112, where the open slot 116 may be generally in a linear shape.

The second radiation element 120 may generally be in an elongated strip shape and may be substantially parallel to the aforementioned open slot 116. Specifically, the second radiation element 120 has a first end 121 and a second end 122, where the second end 122 is an open end. In some embodiments, the second radiation element 120 is adjacent to the first branch 111 and third branch 113 of the first radiation element 110. A first coupling gap GC1 may be formed between the first radiation element 110 and the second radiation element 120. It should be noted that the term “adjacent” as used in this specification refers to a distance between two corresponding components being less than a predetermined value (e.g., 10 mm or less), but generally does not include direct physical contact (i.e., zero spacing).

The third radiation element 130 includes a protruding branch 135 and a widening portion 136. Each of the protruding branch 135 and the widening portion 136 is coupled to a second feeding point FP2. The second feeding point FP2 may be coupled to a positive electrode of a second signal source 192, and a negative electrode of the second signal source 192 may be coupled to the ground voltage VSS. For example, the second signal source 192 may be another radio frequency module, which is different from the aforementioned first signal source 191.

The fourth radiation element 140 may generally be of medium length (in comparison with the second radiation element 120). Specifically, the fourth radiation element 140 has a first end 141 and a second end 142. The first end 141 of the fourth radiation element 140 is coupled to the first end 121 of the second radiation element 120, and the second end 142 of the fourth radiation element 140 is an open end. For example, the second end 122 of the second radiation element 120 and the second end 142 of the fourth radiation element 140 may extend in generally opposite directions away from each other. In some embodiments, the fourth radiation element 140 is adjacent to the widening portion 136 of the third radiation element 130. A second coupling gap GC2 may be formed between the third radiation element 130 and the fourth radiation element 140.

The fifth radiation element 150 may generally be in a shorter strip shape (relative to the fourth radiation element 140) and may be substantially perpendicular to both the second radiation element 120 and the fourth radiation element 140. Specifically, the fifth radiation element 150 has a first end 151 and a second end 152. The first end 151 is coupled to the tunable circuit 180, and the second end 152 is coupled to the first end 121 of the second radiation element 120 and the first end 141 of the fourth radiation element 140. That is, both the second radiation element 120 and the fourth radiation element 140 may be coupled to the tunable circuit 180 via the fifth radiation element 150. In some embodiments, the combination of the second radiation element 120, the fourth radiation element 140, and the fifth radiation element 150 may generally form a T-shaped configuration.

The sixth radiation element 160 may generally be in a smaller L-shaped configuration. Specifically, the sixth radiation element 160 has a first end 161 and a second end 162. The first end 161 is coupled to the ground voltage VSS, and the second end 162 is an open end that may extend in the direction toward the fourth radiation element 140. In some embodiments, the second end 162 of the sixth radiation element 160 is adjacent to the protruding branch 135 of the third radiation element 130. A third coupling gap GC3 may be formed between the third radiation element 130 and the sixth radiation element 160.

The seventh radiation element 170 may generally be in a larger L-shaped configuration (compared to the sixth radiation element 160). Specifically, the seventh radiation element 170 has a first end 171 and a second end 172. The first end 171 of the seventh radiation element 170 is coupled to the first end 141 of the fourth radiation element 140, and the second end 172 of the seventh radiation element 170 is an open end. For example, the second end 122 of the second radiation element 120 and the second end 172 of the seventh radiation element 170 may extend in generally the same direction. In some embodiments, the seventh radiation element 170 is adjacent to the second radiation element 120, and a fourth coupling gap GC4 may be formed between them.

The tunable circuit 180 is coupled to the ground voltage VSS. In some embodiments, the tunable circuit 180 provides a variable impedance value Z to the fifth radiation element 150 according to a control signal SC. For example, the control signal SC may be generated by a processor based on a user input (not shown), although it is not limited thereto.

In some embodiments, the antenna system 100 further includes a carrier element 190 and a conductive via element 195 passing through the carrier element 190. The carrier element 190 may be made of a nonconductive material, and its shape and configuration are not particularly limited in the present disclosure. For example, the carrier element 190 may be implemented using an FR4 (Flame Retardant 4) substrate, a printed circuit board (PCB), or a flexible printed circuit (FPC). Specifically, the carrier element 190 has a first surface E1 and a second surface E2 on opposite sides. The first radiation element 110, the second radiation element 120, the third radiation element 130, the fourth radiation element 140, the fifth radiation element 150, and the sixth radiation element 160 may all be disposed on the first surface E1 of the carrier element 190, while the seventh radiation element 170 may be disposed on the second surface E2. The tunable circuit 180 may be disposed on either the first surface E1 or the second surface E2 of the carrier element 190.

Additionally, the seventh radiation element 170 may be coupled to the first end 141 of the fourth radiation element 140 via the conductive via element 195. It should be understood that the conductive via element 195 is an optional component. If the conductive via element 195 is omitted, the fourth radiation element 140 and the seventh radiation element 170 may be coupled at the same edge of the carrier element 190. In some embodiments, the fifth radiation element 150 has a vertical projection on the second surface E2 of the carrier element 190, and this vertical projection may at least partially overlap with the seventh radiation element 170.

In a preferred embodiment, the first radiation element 110, the second radiation element 120, and the fifth radiation element 150 may form a first antenna structure of the antenna system 100, and the third radiation element 130, the fourth radiation element 140, the fifth radiation element 150, the sixth radiation element 160, and the seventh radiation element 170 may form a second antenna structure of the antenna system 100. It should be noted that since the first antenna structure and the second antenna structure share the fifth radiation element 150 and the tunable circuit 180, the overall size of the antenna system 100 can be further reduced.

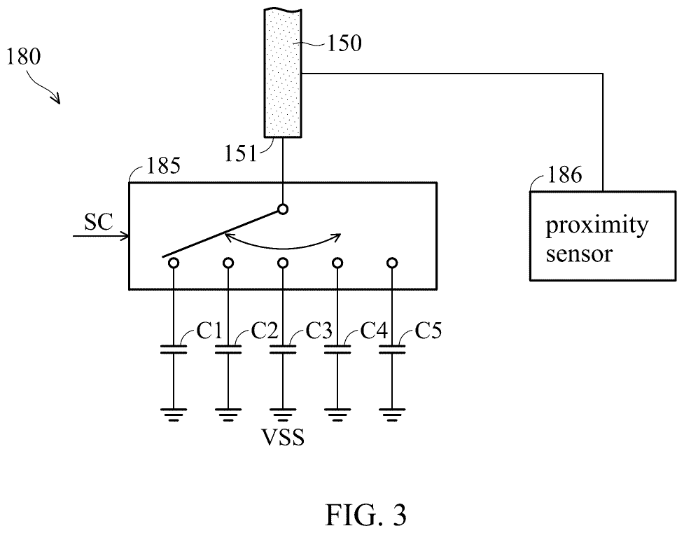

FIG. 3 is a structural diagram of the tunable circuit 180 according to an embodiment of the present disclosure. In the embodiment of FIG. 3, the tunable circuit 180 includes a switch element 185, a first capacitor C1, a second capacitor C2, a third capacitor C3, a fourth capacitor C4, and a fifth capacitor C5. For example, all of the first capacitor C1, the second capacitor C2, the third capacitor C3, the fourth capacitor C4, and the fifth capacitor C5 may be coupled to the ground voltage VSS and may have different capacitance values. Specifically, one end of the switch element 185 is coupled to the first end 151 of the fifth radiation element 150, and the other end of the switch element 185 is switchable between the first capacitor C1, the second capacitor C2, the third capacitor C3, the fourth capacitor C4, and the fifth capacitor C5 based on the control signal SC. In other words, if the tunable circuit 180 uses the switch 185 to select one of the first capacitor C1, the second capacitor C2, the third capacitor C3, the fourth capacitor C4, and the fifth capacitor C5, the fifth radiation element 150 will be coupled to the ground voltage VSS via the selected capacitor. The unselected capacitors remain in an open-circuit state and do not affect the variable impedance value Z of the tunable circuit 180. In other embodiments, the tunable circuit 180 may include fewer or more capacitors depending on the specific application needs.

In some embodiments, the tunable circuit 180 further includes a proximity sensor 186, which is also coupled to the fifth radiation element 150. The second radiation element 120, the fourth radiation element 140, the fifth radiation element 150, and the seventh radiation element 170 may all serve as sensing pads of the proximity sensor 186. Accordingly, the antenna system 100 may also function as a hybrid antenna, capable of providing both proximity sensing and Specific Absorption Rate (SAR) suppression without requiring additional design area.

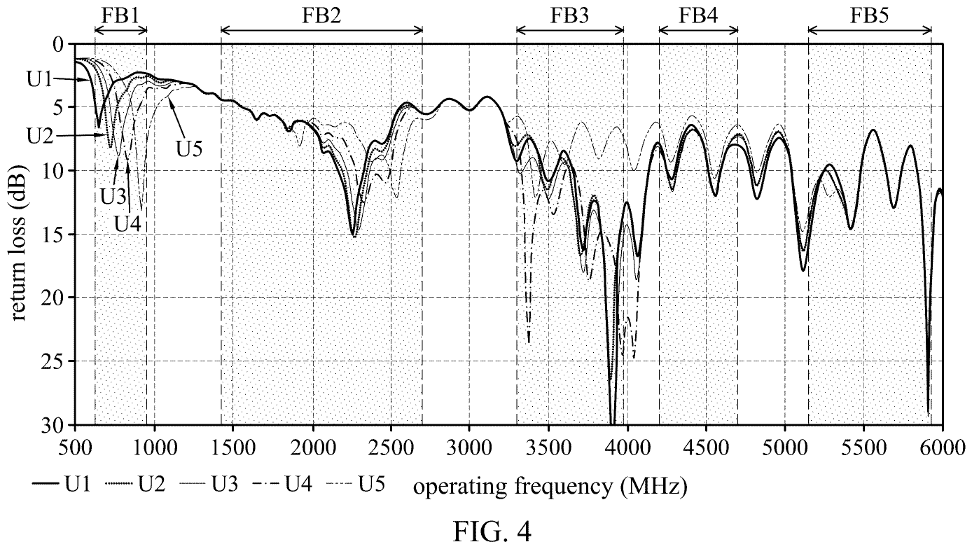

FIG. 4 shows a return loss diagram of the first antenna structure of the antenna system 100 according to an embodiment of the present disclosure. The horizontal axis represents the operating frequency (MHz), and the vertical axis represents the return loss (dB). As shown in FIG. 4, a first curve U1 represents the operating characteristics of the first antenna structure when the switch 185 of the tunable circuit 180 is switched to the first capacitor C1; a second curve U2 represents the operating characteristics of the first antenna structure when the switch 185 of the tunable circuit 180 is switched to the second capacitor C2; a third curve U3 represents of the first antenna structure when the switch 185 of the tunable circuit 180 is switched to the third capacitor C3; a fourth curve U4 represents the operating characteristics of the first antenna structure when the switch 185 of the tunable circuit 180 is switched to the fourth capacitor C4; and a fifth curve U5 represents the operating characteristics of the first antenna structure when the switch 185 of the tunable circuit 180 is switched to the fifth capacitor C5.

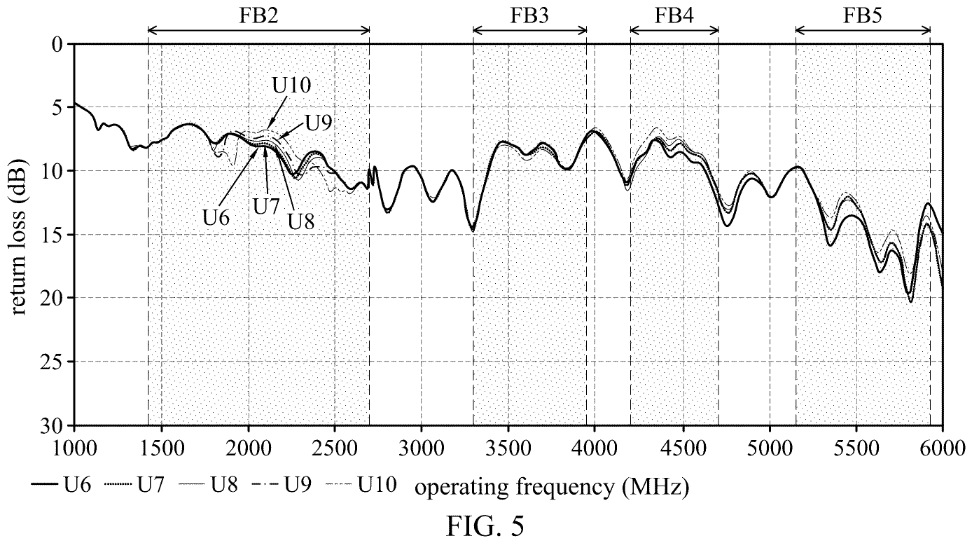

FIG. 5 illustrates the return loss diagram of the second antenna structure of the antenna system 100 according to an embodiment of the present disclosure. The horizontal axis represents the operating frequency (MHz), and the vertical axis represents the return loss (dB). As shown in FIG. 5, a sixth curve U6 represents the operating characteristics of the second antenna structure when the switch 185 of the tunable circuit 180 is switched to the first capacitor C1; a seventh curve U7 represents the operating characteristics of the second antenna structure when the switch 185 of the tunable circuit 180 is switched to the second capacitor C2; an eighth curve U8 represents the operating characteristics of the second antenna structure when the switch 185 of the tunable circuit 180 is switched to the third capacitor C3; a ninth curve U9 represents the operating characteristics of the second antenna structure when the switch 185 of the tunable circuit 180 is switched to the fourth capacitor C4; and a tenth curve U10 for the fifth capacitor C5.

Based on the measurement results shown in FIGS. 4 and 5, the antenna system 100 can cover a first frequency band FB1, a second frequency band FB2, a third frequency band FB3, a fourth frequency band FB4, and a fifth frequency band FB5. For example, the first frequency band FB1 may range from 617 MHz to 960 MHz, the second frequency band FB2 may range from 1427 MHz to 2690 MHz, the third frequency band FB3 may range from 3300 MHz to 3980 MHz, the fourth frequency band FB4 may range from 4200 MHz to 4700 MHz, and the fifth frequency band FB5 may range from 5150 MHz to 5925 MHz. Therefore, the antenna system 100 is capable of supporting wideband operation of GPS (Global Positioning System) and LTE (Long Term Evolution).

In some embodiments, the component dimensions and parameters of the antenna system 100 may be as follows. In the first radiation element 110, the length L1 of the first branch 111 may be substantially equal to 0.25 wavelength (λ/4) of the second frequency band FB2 of the antenna system 100; the length L2 of the second branch 112 may be substantially to 0.25 wavelength (λ/4) of the third frequency band FB3; the length L3 of the third branch 113 may be substantially equal to 0.25 wavelength (λ/ 4) of the fourth frequency band FB4; and the length L4 of the fourth branch 114 may be substantially equal to 0.25 wavelength (λ/4) of the fifth frequency band FB5. The total length L5 of the second radiation element 120 and the fifth radiation element 150 may be from 0.125 to 0.25 wavelength (λ/8~λ/4) of the first frequency band FB1. The length L6 of the protruding branch 135 of the third radiation element 130 may be from 0.125 to 0.25 wavelength (λ/8~λ/4) of the fourth frequency band FB4. The total length L7 of the fourth radiation element 140 and the fifth radiation element 150 may be from 0.125 to 0.25 wavelength (λ/8~λ/4) of the second frequency band FB2. The length L8 of the sixth radiation element 160 may be from 0.125 to 0.25 wavelength (λ/8~λ/4) of the fourth frequency band FB4. The length L9 of the seventh radiation element 170 may be substantially equal to 0.25 wavelength (λ/4) of any of the second to fifth frequency bands (FB2, FB3, FB4, or FB5). The thickness H1 of the carrier element 190 may range from 0.2 mm to 10 mm. The width of the first coupling gap GC1 may be from 0.15 mm to 4 mm. The width of the second coupling gap GC2 may be from 0.15 mm to 4 mm. The width of the third coupling gap GC3 may be from 0.15 mm to 1 mm. The width of the fourth coupling gap GC4 may be between 0.15 mm and 5 mm. The capacitance of the first capacitor C1 may be between 12 pF and 18 pF, for example, about 15 pF. The capacitance of the second capacitor C2 may be between 4 pF and 7 pF, for example, about 5.29 pF. The capacitance of the third capacitor C3 may be between 2.5 pF and 4 pF, for example, about 3.26 pF. The capacitance of the fourth capacitor C4 may be between 1.5 pF and 2.5 pF, for example, about 1.9 pF. The capacitance of the fifth capacitor C5 may be between 0.5 pF and 1.5 pF, for example, about 1 pF. These ranges of component dimensions and parameters are derived from extensive experimental results and are conducive to optimizing the operational bandwidth and impedance matching of the antenna system 100, while also enhancing the isolation between the first and second antenna structures of the antenna system 100.

The present disclosure provides a novel antenna system. Compared with conventional designs, the antenna system disclosed herein offers advantages such as support for Multi-Input and Multi-Output (MIMO) operation, reduction in overall antenna size, and enhancement in overall antenna bandwidth, making it highly suitable for various types of mobile communication devices.

It is noteworthy that the component dimensions, shapes, parameters, and frequency ranges described above are not limitations of the present disclosure. Antenna designers may adjust these settings based on different requirements. The antenna system of the present disclosure is not limited to the configurations illustrated in FIGS. 1 to 5. The invention may include any one or more features of any one or more of the embodiments shown in FIGS. 1 to 5. In other words, not all illustrated features must be simultaneously implemented in the antenna system of the present disclosure.

In this specification and the claims, ordinal numbers such as “first,” “second,” “third,” etc., do not imply any sequential order. They are only used to distinguish between different elements with the same name.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna system, comprising:
a first radiation element, having a first feeding point;
a second radiation element, wherein the second radiation element is adjacent to the first radiation element;
a third radiation element, having a second feeding point;
a fourth radiation element, wherein the fourth radiation element is adjacent to the third radiation element;
a tunable circuit, coupled to a ground voltage, wherein the tunable circuit provides a variable impedance value according to a control signal;
a fifth radiation element, wherein the second radiation element and the fourth radiation element are coupled through the fifth radiation element to the tunable circuit;
a sixth radiation element, coupled to the ground voltage, wherein the sixth radiation element is adjacent to the third radiation element; and
a seventh radiation element, coupled to the fourth radiation element, wherein the seventh radiation element is adjacent to the second radiation element;
wherein a first antenna structure is formed by the first radiation element, the second radiation element, and the fifth radiation element;
wherein a second antenna structure is formed by the third radiation element, the fourth radiation element, the fifth radiation element, the sixth radiation element, and the seventh radiation element.

2. The antenna system of claim 1, further comprising:
a carrier element, having a first surface and a second surface opposite to each other, wherein the first radiation element, the second radiation element, the third radiation element, the fourth radiation element, the fifth radiation element, and the sixth radiation element are disposed on the first surface, and the seventh radiation element is disposed on the second surface; and
a conductive via element, wherein the seventh radiation element is coupled to the fourth radiation element through the conductive via element.

3. The antenna system of claim 1, wherein a first coupling gap is formed between the first radiation element and the second radiation element, and a width of the first coupling gap is between 0.15 mm and 4 mm.

4. The antenna system of claim 1, wherein a second coupling gap is formed between the third radiation element and the fourth radiation element, and a width of the second coupling gap is between 0.15 mm and 4 mm.

5. The antenna system of claim 1, wherein a third coupling gap is formed between the third radiation element and the sixth radiation element, and a width of the third coupling gap is between 0.15 mm and 1 mm.

6. The antenna system of claim 1, wherein a fourth coupling gap is formed between the second radiation element and the seventh radiation element, and a width of the fourth coupling gap is between 0.15 mm and 5 mm.

7. The the antenna system of claim 1, wherein the tunable circuit comprises:
a first capacitor, coupled to the ground voltage;
a second capacitor, coupled to the ground voltage;
a third capacitor, coupled to the ground voltage;
a fourth capacitor, coupled to the ground voltage;
a fifth capacitor, coupled to the ground voltage; and
a switch element, coupled to the fifth radiation element, wherein the switch element is switchable between the first capacitor, the second capacitor, the third capacitor, the fourth capacitor, and the fifth capacitor according to the control signal.

8. The antenna system of claim 7, wherein the capacitance of the first capacitor is between 12 pF and 18 pF, the capacitance of the second capacitor is between 4 pF and 7 pF, the capacitance of the third capacitor is between 2.5 pF and 4 pF, the capacitance of the fourth capacitor is between 1.5 pF and 2.5 pF, and the capacitance of the fifth capacitor is between 0.5 pF and 1.5 pF.

9. The antenna system of claim 7, wherein the tunable circuit further comprises:
a proximity sensor, coupled to the fifth radiation element, wherein the second radiation element, the fourth radiation element, the fifth radiation element, and the seventh radiation element each serve as a sensing pad of the proximity sensor.

10. The antenna system of claim 1, wherein the antenna system covers a first frequency band, a second frequency band, a third frequency band, a fourth frequency band, and a fifth frequency band.

11. The antenna system of claim 10, wherein the first frequency band is between 617 MHz and 960 MHz, the second frequency band is between 1427 MHz and 2690 MHz, the third frequency band is between 3300 MHz and 3980 MHz, the fourth frequency band is between 4200 MHz and 4700 MHz, and the fifth frequency band is between 5150 MHz and 5925 MHz.

12. The antenna system of claim 10, wherein the first radiation element comprises a first branch, a second branch, a third branch, and a fourth branch, and an open slot is formed between the first branch and the second branch.

13. The antenna system of claim 12, wherein a length of the first branch is substantially equal to 0.25 wavelength of the second frequency band.

14. The antenna system of claim 12, wherein a length of the second branch is substantially equal to 0.25 wavelength of the third frequency band.

15. The antenna system of claim 12, wherein a length of the third branch is substantially equal to 0.25 wavelength of the fourth frequency band.

16. The antenna system of claim 12, wherein a length of the fourth branch is substantially equal to 0.25 wavelength of the fifth frequency band.

17. The antenna system of claim 10, wherein a total length of the second radiation element and the fifth radiation element is from 0.125 to 0.25 wavelength of the first frequency band.

18. The antenna system of claim 10, wherein the third radiation element comprises a protruding branch, and a length of the protruding branch is from 0.125 to 0.25 wavelength of the fourth frequency band.

19. The antenna system of claim 10, wherein a total length of the fourth radiation element and the fifth radiation element is from 0.125 to 0.25 wavelength of the second frequency band.

20. The antenna system of claim 10, wherein a length of the sixth radiation element is from 0.125 to 0.25 wavelength of the fourth frequency band.
